(19) United States
(12) Patent Application Publication
(10) Pub. No.: US 2026/0350576 A1
(43) Pub. Date: Nov. 5, 2026

(54) REGION BASED DYNAMIC PREDICTION FOR IN VEHCILE DIGITAL WALLET

(71) Applicant: GM Global Technology Operations LLC, Detroit, MI (US)

(72) Inventors: Maria Edith Trudgeon, Bloomfield Hills, MI (US); Sri Tulasi Palacharla, Waterford, MI (US); Milutin Ivanovski, Macomb Township, MI (US); Luke John Popiel, Oxford, MI (US)

(73) Assignee: GM Global Technology Operations LLC, Detroit, MI (US)

(21) Appl. No.: 19/197,627

(22) Filed: May 2, 2025

(51) Int. Cl. G06Q 20/22; G06Q 20/40

(52) U.S. Cl. CPC G06Q 20/227; G06Q 20/4014; G06Q 20/4015

(57) ABSTRACT

A system and method include receiving, at a vehicle, an indication of an initiated purchase initiated by a user of the vehicle, detecting a location of the vehicle, and receiving a user profile associated with the user of the vehicle, the user profile including one or more payment methods for the user. Based on the location of the vehicle, the method also includes dynamically predicting a payment method of the one or more payment methods for the user, and displaying, in a graphical user interface displayed on a screen in communication with data processing hardware of the vehicle, the dynamically predicted payment method for the user to apply to the initiated purchase.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a region based dynamic prediction for an in vehicle digital wallet. In the current landscape of point of sale (POS) payments, transactions are typically completed using physical payment methods such as credit cards, debit cards, and cash. Consumers often carry these payment methods in a physical wallet, which they present at the time of purchase. This process involves the consumer selecting the appropriate card or cash, handing it to the cashier, and then waiting for the transaction to be processed. In the case of card payments, this may involve swiping, inserting, or tapping the card on a POS terminal, followed by entering a PIN or providing a signature.

Carrying a physical wallet with multiple payment methods can be cumbersome for consumers. It requires them to remember which payment methods they have available and to select the most appropriate one for each transaction. This can lead to situations where a consumer might inadvertently use a less advantageous payment method, such as a card with higher fees or lower rewards, instead of a more beneficial option. Additionally, the need to manually select and present a payment method can slow down the transaction process and increase the cognitive load on the consumer, making the overall experience less efficient and more prone to errors.

### SUMMARY

One aspect of the disclosure provides a computer-implemented method for region based dynamic predictions for an in vehicle digital wallet that when executed on data processing hardware causes the data processing hardware to perform operations that include receiving, at a vehicle, an indication of an initiated purchase initiated by a user of the vehicle, detecting a location of the vehicle, and receiving a user profile associated with the user of the vehicle, the user profile including one or more payment methods for the user. Based on the location of the vehicle, the operations also include dynamically predicting a payment method of the one or more payment methods for the user, and displaying, in a graphical user interface (GUI) displayed on a screen in communication with data processing hardware of the vehicle, the dynamically predicted payment method for the user to apply to the initiated purchase.

Implementations of the disclosure may include one or more of the following optional features. In some implementations, the operations further include, before receiving the indication of the initiated purchase, detecting that the user has accessed the vehicle. In these implementations, detecting that the user has accessed the vehicle further may further include authenticating an identity of the user, and in response to authenticating the identity of the user, activating the user profile of the user. In some examples, the user profile further includes a payment history of the user. In these examples, dynamically predicting the payment method of the one or more payment methods is further based on a currency associated with the location of the vehicle. In some implementations, dynamically predicting the payment method of the one or more payment methods is further based on a currency associated with the location of the vehicle.

In some examples, the operations further include receiving, in the GUI displayed on the screen, a user input indication indicating selection of a graphical element representing the predicted payment method, and applying the predicted payment method to the initiated purchase. In some implementations, the operations further include receiving, in the GUI displayed on the screen, a user input indication indicating selection of a graphical element representing a rejection of the predicted payment method, and refining the user profile associated with the user to incorporate the rejection of the predicted payment method as feedback. In these implementations, the operations may further include displaying, in the GUI displayed on the screen, a user prompt prompting the user to enter payment information for the initiated purchase. In some examples, dynamically predicting the payment method is further based on service information of a vendor processing the initiated purchase initiated by the user.

Another aspect of the disclosure provides a system including a region based dynamic prediction for an in vehicle digital wallet including data processing hardware and memory hardware in communication with the data processing hardware. The memory hardware stores instructions that when executed by the data processing hardware cause the data processing hardware to perform operations that include receiving, at a vehicle, an indication of an initiated purchase initiated by a user of the vehicle, detecting a location of the vehicle, and receiving a user profile associated with the user of the vehicle, the user profile including one or more payment methods for the user. Based on the location of the vehicle, the operations also include dynamically predicting a payment method of the one or more payment methods for the user, and displaying, in a graphical user interface (GUI) displayed on a screen in communication with data processing hardware of the vehicle, the dynamically predicted payment method for the user to apply to the initiated purchase.

This aspect may include one or more of the following optional features. In some implementations, the operations further include, before receiving the indication of the initiated purchase, detecting that the user has accessed the vehicle. In these implementations, detecting that the user has accessed the vehicle further may further include authenticating an identity of the user, and in response to authenticating the identity of the user, activating the user profile of the user. In some examples, the user profile further includes a payment history of the user. In these examples, dynamically predicting the payment method of the one or more payment methods is further based on a currency associated with the location of the vehicle. In some implementations, dynamically predicting the payment method of the one or more payment methods is further based on a currency associated with the location of the vehicle.

In some examples, the operations further include receiving, in the GUI displayed on the screen, a user input indication indicating selection of a graphical element representing the predicted payment method, and applying the predicted payment method to the initiated purchase. In some implementations, the operations further include receiving, in the GUI displayed on the screen, a user input indication indicating selection of a graphical element representing a rejection of the predicted payment method, and refining the user profile associated with the user to incorporate the rejection of the predicted payment method as feedback. In these implementations, the operations may further include displaying, in the GUI displayed on the screen, a user prompt prompting the user to enter payment information for the initiated purchase. In some examples, dynamically predicting the payment method is further based on service information of a vendor processing the initiated purchase initiated by the user.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system including a region based dynamic prediction for an in vehicle digital wallet.

FIG. 2 is a schematic view of example components of the system of FIG. 1.

FIG. 3 is a dynamic prediction flowchart for the system of FIG. 1.

FIGS. 4A-4C are schematic views of a graphical user interface of the system of FIG. 1.

FIG. 5 is a flowchart of an example arrangement of operations for a method for region based dynamic predictions for an in vehicle digital wallet.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

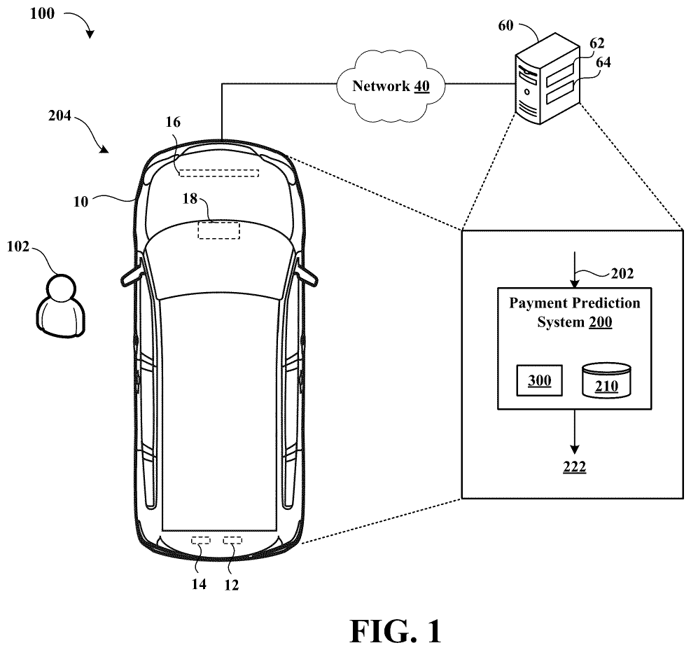

Referring to FIG. 1, in some implementations, a system 100 includes a vehicle 10 in communication with a remote system 60 via a network 40. The vehicle 10 and/or the remote system 60 include a payment prediction system 200 that executes while a user 102 is operating the vehicle 10. Briefly, and as described in further detail below, the payment prediction system 200 receives an indication of an initiated purchase 202 initiated by the user 102 of the vehicle 10, dynamically predicts a payment method 222 for the initiated purchase 202 based on a user profile 220 of the user 102, and displays the dynamically predicted payment method 222 to the user 102 to apply to the initiated purchase 202. Notably, by dynamically predicting the payment method 222 for the user 102 that best fits the particular location 204 and/or initiated purchase 202, the payment prediction system 200 eliminates the need for the user 102 to open any digital or physical wallet, or take time to determine the most appropriate payment methods independently. Moreover, the payment prediction system 200 may track patterns (e.g., traveling across borders, using different vendors, business travel vs. personal travel, etc.) in the selected payment methods 222 by the user 102 to continuously improve its dynamic predictions for the user 102.

In the example shown, the payment prediction system 200 is implemented within the vehicle 10. However, the payment prediction system 200 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 12 to perform operations. Additionally, while the payment prediction system 200 is described as being implemented by the data processing hardware 12 and memory hardware 14 of the vehicle 10, the operations can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 further includes a sensor system 16 configured to capture sensor data of the vehicle 10. The vehicle 10 may continuously, or at least during periodic intervals, receive the sensor data captured by the sensor system 16 to determine a location 204 of the vehicle 10. Some examples of sensor data include global positioning data, motion data, image data, connection data, noise data, speech data, or other data indicative of a relative location 20 of the vehicle 10. As shown, the vehicle 10 further includes a graphical user interface (GUI) 16 through which the user 102 of the vehicle 10 interacts with the payment prediction system 200.

The network 40 may include a wireless local area network (WLAN) that facilitates communication and interoperability between the vehicle 10 and the remote system 60 within the environment of the vehicle 10. Thus, the network 40 can include Wireless Fidelity (WiFi®) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth, Near Field Communication (NFC), or any other wireless standards, or Ethernet (e.g., IEEE 802.3). The system 100 may additionally include one or more access points (AP) (not shown) configured to facilitate wireless communication between the vehicle 10 and the remote system 60.

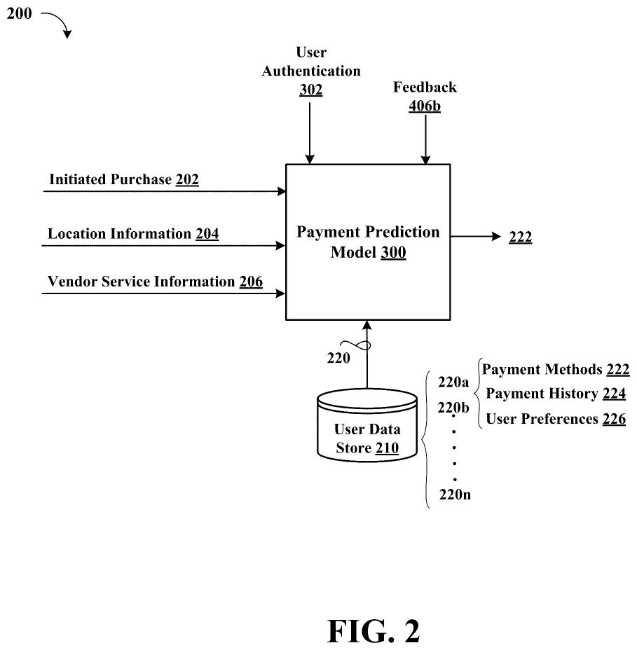

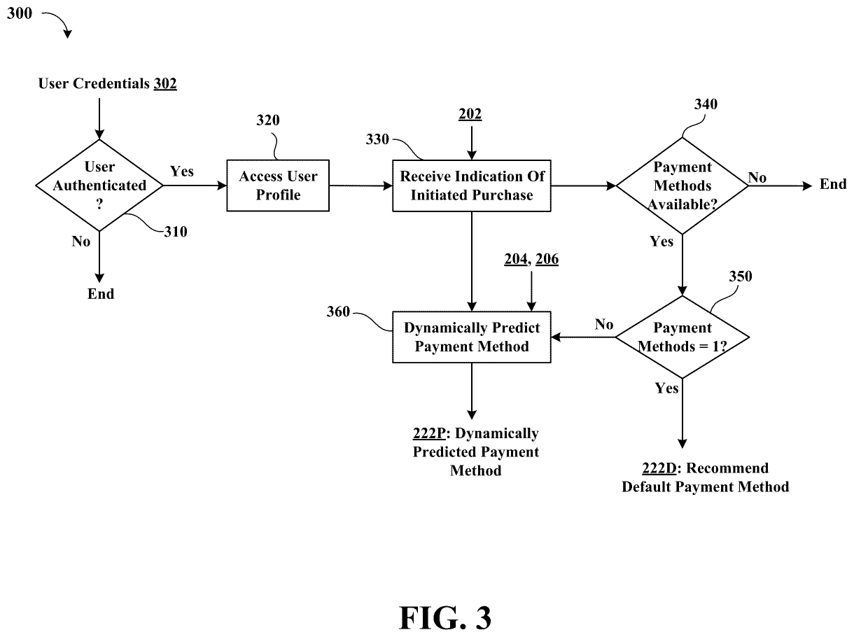

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the payment prediction system 200 is shared across the vehicle 10 and the remote system 60. As described in greater detail below with reference to FIGS. 2 and 3, the payment prediction system 200 executing on the vehicle 10 and/or the remote system 60 executes a payment prediction model 300 configured to receive the indication of the initiated purchase 202 by the user 102 and, after dynamically predicting the payment method 222 that is most appropriate for the purchase 202, displaying the predicted payment method 222 for the user 102 to apply to the initiated purchase 202.

The payment prediction system 200 further has access to a user data store 210 (also referred to as a data store 210) stored on the memory hardware 14, 64 of the system 100. The user data store 210 may store one or more user profiles 220, 220a-220n, where each user profile 220 may be associated with an individual user 102 and include one or more payment methods 222, the payment history 224 of the user 102, and/or use preferences 226 of the user. As used herein, the one or more payment methods 222 may include financial institutions, where such payment methods and/or credentials are securely stored within the user profile 220, and include, but are not limited to, payment card accounts (e.g., credit cards, debit cards, prepaid cards, charge cards, virtual cards, etc.), bank accounts (e.g., checking, savings, automated clearing house transfers, real-time payments, electronic funds transfers, or other similar bank-to-bank transfer protocols), stored value accounts (e.g., proprietary wallet balances, digital gift cards, transit accounts, campus accounts, etc.) digital currency accounts (e.g., cryptocurrencies, stablecoins, central bank digital currencies, etc.), peer-to-peer payment service accounts, buy now, pay layer accounts, loyalty and rewards program accounts, and digital coupons and vouchers. The payment history 224 may be a log of historical initiated payments 202 initiated by the user 102 along with the corresponding payment method 222 used with that particular historical initiated payment 202. Based on this historical data of the payment history 224 of the user 102, the payment prediction system 200 may identify patterns (e.g., a threshold number of transactions using the same payment method 222 at the same location 204) and store user preferences 226 of the user 102. For instance, the payment prediction system 200 may identify that the user 102 uses a specific payment method 222 at car washes, or that the user 102 frequently uses a payment method 222 associated with a loyalty program when initiating payment 202 at a grocery store. In addition to patterns identified from the payment history 224 of the user 102, the user preferences 226 (e.g., only use a particular payment method 222 with a particular cash back rewards program when initiating payment 202 to pay for gas) may be manually entered into the user profile 220 by the user 102.

With particular reference to FIG. 3, a flowchart of the algorithm executed by the payment prediction model 300 is shown. As the user 102 approaches the vehicle 10 to access the vehicle 10, at operation 310, the vehicle 10 and/or the payment prediction model 300 may detect user credential 302, if any, of the user 102 and determine whether the user 102 is an authenticated user of the vehicle 10. In some instances, the vehicle 10 and/or the payment prediction model 300 detects the user credentials 302 based on a registered key fob and/or user device (e.g., a mobile device, smart watch, etc.) entering a detection range of the vehicle 10. The vehicle 10 may be equipped with low-frequency (LF) antennas that monitor for user credentials 302 before the vehicle 10 initiates an authentication process at operation 310. In other instances, the vehicle 10 may detect the user credentials 302 when the user 102 is within a network of the vehicle, such as WiFi®, Low-Rate Wireless Personal Area Networks, WiMAX, 3G, 4G, LTE, 5G, DSL, Bluetooth, NFC, or any other wireless standards.

If, at operation 310, if the payment prediction model 300 does not detect that the user credentials 302 indicate that the user 102 is an authenticated user 102 of the payment prediction system 200, the payment prediction model 300 may return to a dormant state (e.g., return to sleep) until an authenticated user 102 approaches/access the vehicle 10. Alternatively, if the payment prediction model 300 detects that the user 102 has accessed the vehicle 10 and authenticates the identity of the user 102 (i.e., via the user credentials 302), the payment prediction model 300 proceeds to operation 320 and activates the user profile 220 of the authenticated user 102. For instance, the payment prediction model 300 may retrieve the user profile 220 associated with the authenticated user 102 and store the user profile 220 locally (e.g., on the memory hardware 14 of the vehicle).

At operation 330, the payment prediction model 300 receives the indication of the initiated payment 202 initiated by the authenticated user 102. For instance, the initiated payment 202 may be for a retail store that the authenticated user 102 shops at frequently. At operation 340, the payment prediction model 300 may determine whether the user profile 220 includes payment methods 222. If the user profile 220 does not include any payment methods 222, the payment prediction model 300 may prompt the user 102 to enter a payment method 222 for future use with the user profile 220. Conversely, if the user profile 220 includes payment methods 222, the payment prediction model 300 determines, at operation 350, whether a number of payment methods 222 in the user profile 220 is equal to one (1). If the user profile 102 only includes one (1) payment method 222 (i.e., a default payment method 222D), the payment prediction model 300 may generate, for output, a recommendation to the user 102 to use the default payment method 222D to apply to the initiated purchase 202.

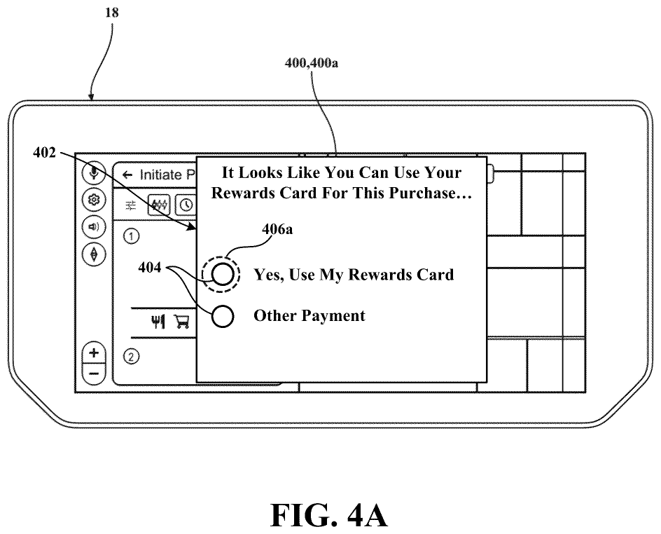

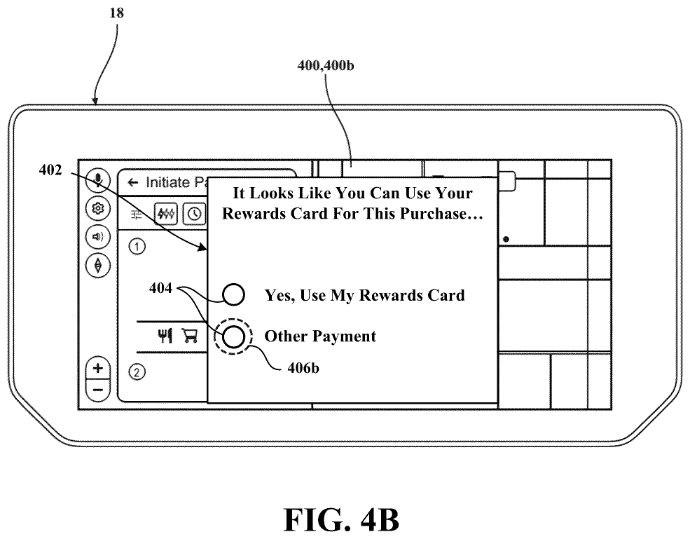

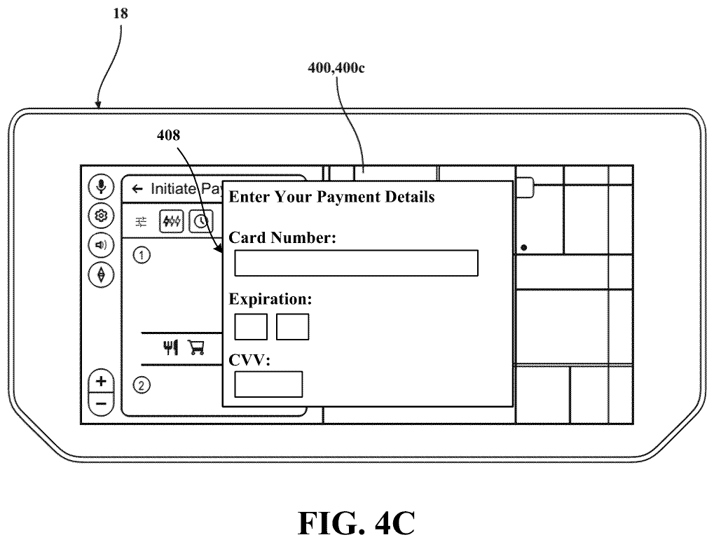

If, however, at operation 350, the payment prediction model 300 determines that the user profile 202 includes more than one (1) payment method 222, the payment prediction model 300 proceeds to operation 360 to perform payment method 222 arbitration to dynamically predict the best payment method 222 for the initiated purchase 202 based on a location 204 of the vehicle 10. In these cases, the payment prediction model 300 detects, based on the sensor data measured by the sensor system 16, the location 204 of the vehicle 10, and dynamically predicts the payment method 222P based on the location 204 of the vehicle 10. After dynamically predicting the payment method 222P, the payment method 300 may display, in a graphical user interface (GUI) (FIGS. 4A-4C) the dynamically predicted payment method 222P for the user 102 to apply to the initiated purchase 202.

In some instances, the payment prediction model 300 may detect the location 204 of the vehicle 10 as being in a particular country having a local currency. In these instances, the payment prediction model 300 may dynamically predict a payment method 222P corresponding to the local currency of the location of the vehicle 204. The payment prediction model 300 may further consider additional elements of the user profile 220 when determining the dynamically predicted payment prediction 222P. The payment prediction model 300 may generate its prediction based on the user preferences 224 derived from the payment history 226 of the user 102.

In addition to the location 204 of the vehicle 10, the payment prediction model 300 may receive vendor service information 206 associated with the vendor processing the initiated purchase 202 initiated by the user 102. Given that not all vendors may be equipped to process all types of payment methods 222, the vendor service information 206 may communicate to the payment prediction model 300 the specific types of payment methods 222 the vendor is capable of processing in transactions. Here, the payment prediction model 300 may discard/ignore any payment methods 222 in the user profile 220 that are not accepted by the vendor based on the vendor service information 206 when performing its payment method arbitration.

Referring to FIGS. 4A-4C, the user 102 interacts with the payment prediction model 300 via a screen 400, 400a-400c of the GUI 16 of the vehicle 10. Here, the payment prediction model 300 presents the payment method 222 in response to receiving the indication of the initiated purchase 202. With particular reference to FIG. 4A, the screen 400A shows a message to the user 102 including a prompt 402 “it looks like you can use your rewards card for this purchase . . . ” In this example, the payment prediction model 300 may determine, based on the location 204 of the vehicle 10, that the vehicle 10 is in the parking lot of a wholesale club that the user 102 often uses with a rewards card payment method 222 associated with the wholesale club, and predict that the user 102 is most likely to benefit from using the rewards card payment method 222 for the initiated payment 202. The GUI 18 may further present, in the screen 400a, graphical elements 404 representing the options “yes, use my rewards card” representing the predicted payment method 222P of the rewards card, and “other payment” representing a rejection of the predicted payment method 222P. In response to the payment prediction model 300 receiving a user input indication 406a indicating selection of the graphical element 404 representing the predicted payment method 222P, the payment prediction model 300 may apply the predicted payment method 222P to the initiated purchase 102 without further input by the user 102.

Referring to FIG. 4B, the user 102 may alternatively determine that the predicted payment method 222P recommended by the payment prediction model 300 is not the correct payment method 222 to apply to the initiated purchase 202. As shown, the payment prediction model 300 may receive, in the GUI 18 displayed on the screen 400b, a user input indication 406b indicating selection of the graphical element 404 representing the rejection of the predicted payment method 222P. Here, the user input indication 406b rejecting the predicted payment method 222P may be recorded as feedback by the payment prediction model 300 to refine future predictions. By incorporating the feedback, the model 300 may dynamically adapt to the purchasing patterns of the user 102 (e.g., as daily commutes, regional travel, vendors, and/or memberships change).

Referring to FIG. 4C, in response to receiving the user input indication 406b indicating selection of the graphical element 404 representing the rejection of the predicted payment method 222P, the screen 400c may display, in the GUI 18, a user prompt 408 prompting the user 102 to enter payment information for the initiated purchase 202. As shown, the user prompt 408 may include text boxes for the credentials of a new payment method 222, such as, the card number, expiration, date, and card verification value (cvv). In some instances, the payment prediction system 200 may further offer to store the entered payment information as a payment method 222 in the user profile 220 for future transactions.

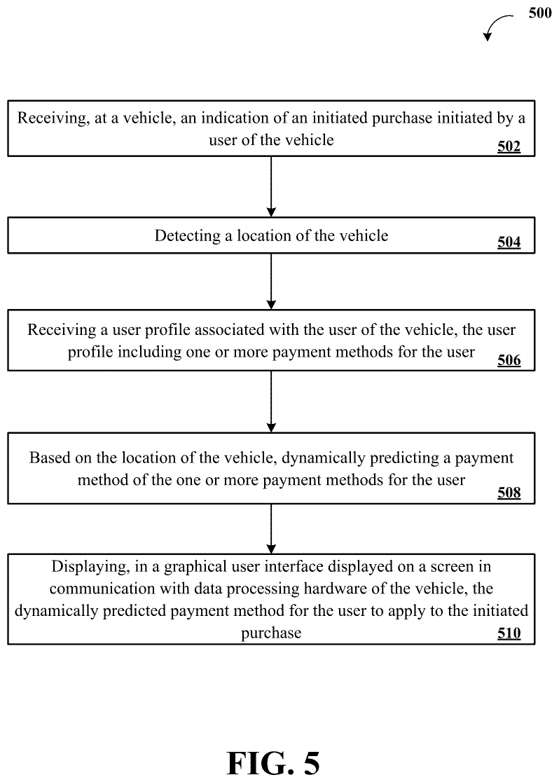

FIG. 5 includes a flowchart of an example arrangement of operations for a method 500 for region based dynamic predictions for an in vehicle digital wallet. The method 500 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 500. At operation 502, the method 500 includes receiving, at a vehicle 10, an indication of an initiated purchase 202 initiated by a user 102 of the vehicle 10. The method 500 also includes, at operation 504, detecting a location 204 of the vehicle 10.

At operation 506, the method 500 further includes receiving a user profile 220 associated with the user 102 of the vehicle 10. Here, the user profile 220 includes one or more payment methods 222 for the user 102. Based on the location 204 of the vehicle 10, the method 500 also includes, at operation 508, dynamically predicting a payment method 222P of the one or more payment methods 222 for the user 102. At operation 510, the method 500 further includes, displaying in a graphical user interface 18 displayed on a screen 400 in communication with data processing hardware 12 of the vehicle 10, the dynamically predicted payment method 222P for the user 102 to apply to the initiated purchase 202.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
detecting that a user has accessed a vehicle by:
authenticating an identity of the user; and
in response to authenticating the identity of the user, activating a user profile of the user;
after activating the user profile of the user, receiving, at the vehicle, an indication of an initiated purchase initiated by the user of the vehicle;
detecting a location of the vehicle based on sensor data captured by a sensor system of the vehicle;
receiving vendor service information associated with a vendor processing the initiated purchase, the vendor service information communicating specific types of payment methods the vendor is capable of processing;
receiving the activated user profile associated with the user of the vehicle, the activated user profile including one or more payment methods for the user;
based on the location of the vehicle and the vendor service information, dynamically predicting a payment method of the one or more payment methods for the user by:
filtering out one or more payment methods from the activated user profile that are not capable of being processed by the vendor; and
selecting from remaining payment methods in the activated user profile, a payment method corresponding to a local currency associated with the location of the vehicle; and
displaying, in a graphical user interface (GUI) displayed on a screen in communication with data processing hardware of the vehicle, the dynamically predicted payment method for the user to apply to the initiated purchase.

2. (canceled)

3. (canceled)

4. The method of claim 1, wherein the user profile further includes a payment history of the user.

5. The method of claim 4, wherein dynamically predicting the payment method of the one or more payment methods is further based on the payment history of the user.

6. (canceled)

7. The method of claim 1, wherein the operations further comprise:
receiving, in the GUI displayed on the screen, a user input indication indicating selection of a graphical element representing the predicted payment method; and
applying the predicted payment method to the initiated purchase.

8. The method of claim 1, wherein the operations further comprise:
receiving, in the GUI displayed on the screen, a user input indication indicating selection of a graphical element representing a rejection of the predicted payment method; and
refining the user profile associated with the user to incorporate the rejection of the predicted payment method as feedback.

9. The method of claim 8, wherein the operations further comprise displaying, in the GUI displayed on the screen, a user prompt prompting the user to enter payment information for the initiated purchase.

10. (canceled)

11. A system comprising:
data processing hardware; and
memory hardware in communication with the data processing hardware, the memory hardware storing instructions that when executed on the data processing hardware cause the data processing hardware to perform operations comprising:
detecting that a user has accessed a vehicle by:
authenticating an identity of the user; and
in response to authenticating the identity of the user, activating a user profile of the user;
after activating the user profile of the user, receiving, at the vehicle, an indication of an initiated purchase initiated by the user of the vehicle;
detecting a location of the vehicle based on sensor data captured by a sensor system of the vehicle;
receiving vendor service information associated with a vendor processing the initiated purchase, the vendor service information communicating specific types of payment methods the vendor is capable of processing;
receiving the activated user profile associated with the user of the vehicle, the activated user profile including one or more payment methods for the user;
based on the location of the vehicle and the vendor service information, dynamically predicting a payment method of the one or more payment methods for the user by:
filtering out one or more payment methods from the activated user profile that are not capable of being processed by the vendor; and
selecting from remaining payment methods in the activated user profile, a payment method corresponding to a local currency associated with the location of the vehicle; and
displaying, in a graphical user interface (GUI) displayed on a screen in communication with data processing hardware of the vehicle, the dynamically predicted payment method for the user to apply to the initiated purchase.

12. (canceled)

13. (canceled)

14. The system of claim 11, wherein the user profile further includes a payment history of the user.

15. The system of claim 14, wherein dynamically predicting the payment method of the one or more payment methods is further based on the payment history of the user.

16. (canceled)

17. The system of claim 11, wherein the operations further comprise:
receiving, in the GUI displayed on the screen, a user input indication indicating selection of a graphical element representing the predicted payment method; and
applying the predicted payment method to the initiated purchase.

18. The system of claim 11, wherein the operations further comprise:
receiving, in the GUI displayed on the screen, a user input indication indicating selection of a graphical element representing a rejection of the predicted payment method; and
refining the user profile associated with the user to incorporate the rejection of the predicted payment method as feedback.

19. The system of claim 18, wherein the operations further comprise displaying, in the GUI displayed on the screen, a user prompt prompting the user to enter payment information for the initiated purchase.

20. (canceled)
